(19) United States
(12) Patent Application Publication
(10) Pub. No.: US 2013/0188402 A1
(43) Pub. Date: Jul. 25, 2013

(54) Subsea DC Transmission System

(71) Applicant: Ove Boe, Tanem (NO)

(72) Inventor: Ove Boe, Tanem (NO)

(21) Appl. No.: 13/825,970

(22) PCT Filed: Feb. 7, 2011
(86) PCT No.: PCT/EP2011/051702

§ 371 Date: Mar. 25, 2013

(30) Foreign Application Priority Data
Sep. 24, 2010 (EP) 10179502.9

(51) Int. Cl. H02M 5/42

(52) U.S. Cl. CPC H02M 5/42
USPC 363/34; 363/13

(57) ABSTRACT

A subsea electrical power transmission system may include a rectifier located at the source of the energy feeding a subsea DC power transmission path, e.g. a transmission cable with DC power. The voltage level can be adjusted to the actual installation and may typically be 100 kV. To reduce the voltage at the destination a step down chopper is used in one embodiment. This may reduce the voltage to a suitable input voltage for a VSD-inverters (VSD: variable speed drive) feeding electrical consumers such as motors.

### CROSS-REFERENCE TO RELATED APPLICATIONS

This application is a U.S. National Stage Application of International Application No. PCT/EP2011/051702 filed Feb. 7, 2011, which designates the United States of America, and claims priority to EP Patent Application No. 10179502.9 filed Sep. 24, 2010 The contents of which are hereby incorporated by reference in their entirety.

### TECHNICAL FIELD

The present disclosure relates to the field of subsea power transmission and in particular to subsea power distribution in a subsea power grid.

### BACKGROUND

As is known from practice, transmission of electrical power to subsea installations is performed by using an alternating current power that is transmitted via isolated cables to the subsea consumers.

A disadvantage of known subsea power transmission systems is that these systems have a limitation in transmission distance.

In view of the above-described situation, there exists a need for an improved technique that enables to provide a subsea power transmission system, while substantially avoiding or at least reducing one or more of the above-identified problems.

### SUMMARY

One embodiment provides a subsea electrical power transmission system comprising: a rectifier being configured for receiving electrical input power with a time varying voltage from a source of electrical energy; and a subsea DC power transmission path connected to the rectifier; the rectifier being configured for converting the electrical input power into a transmission DC power and feeding the transmission DC power into the subsea DC power transmission path.

In a further embodiment, the subsea electrical power transmission system further comprises a step-down converter in the subsea DC power transmission path; the step-down converter being configured for receiving the transmission DC power and providing, in response hereto, a converted DC power, wherein the voltage of the converted DC power is lower than the voltage of the transmission DC power.

In a further embodiment, the voltage of the converted DC power is in a range between 5 kilovolts and 20 kilovolts.

In a further embodiment, the subsea electrical power transmission system further comprises a further converter coupled to the step-down converter, the further converter being configured for receiving the converted DC power and providing in response hereto a converter output power with a time varying voltage.

In a further embodiment, the step-down converter is installed in a dielectric-fluid-filled container.

In a further embodiment, the step-down converter is configured for installation at a seabed.

In a further embodiment, one pole of the transmission DC power is grounded.

In a further embodiment, the subsea DC power transmission path further comprising a power distribution bus.

In a further embodiment, the subsea electrical power transmission system further comprises a switching element for electrically coupling/decoupling a consumer to the power distribution bus.

Another embodiment provides a method of operating a subsea electrical power transmission system, the method comprising: receiving electrical input power with a time varying voltage from a source of electrical energy; and converting the electrical input power into a transmission DC power and feeding the transmission DC power into a subsea DC power transmission path.

In a further embodiment, the method further comprises converting the transmission DC power into a converted DC power, wherein the voltage of the converted DC power is lower than the voltage of the transmission DC power.

In a further embodiment, the method further comprises grounding one pole of a DC power in the subsea DC power transmission path between the source of electrical energy on the one hand and a consumer or terminals to which the electrical consumer is connectable on the other hand.

### BRIEF DESCRIPTION OF THE DRAWINGS

FIG. 1 shows a subsea electrical power transmission system in accordance with embodiments of the herein disclosed subject matter.

### DETAILED DESCRIPTION

Some embodiments of the present disclosure provide a subsea electrical power transmission system comprising a rectifier which is configured for receiving electrical input power with a time varying voltage from a source of electrical energy, and a subsea DC power transmission path connected to the rectifier, the rectifier being configured for converting the electrical input power into a transmission DC power and feeding the transmission DC power into the subsea DC power transmission path.

Rectification of the input power with a time varying voltage provides a DC voltage. A DC voltage allows to reduce cable losses compared to a time varying voltage. Reduced cable losses in turn provide for operation cost efficient subsea installations. Further, in some embodiments the distance that can be bridged with subsea DC power transmission path can be increased compared to AC power transmission.

According to an embodiment, the subsea electrical power transmission system is a subsea electrical power distribution system.

According to an embodiment, the time varying voltage is an AC voltage. Accordingly, in an embodiment the input power is an AC power. Generally herein AC is used in its usual meaning, i.e. “alternating current” meaning that the current (and hence the flow of electrical charges) periodically changes direction.

According to an embodiment, the subsea electrical power transmission system is a subsea electricity network for supplying electrical power to a plurality of electrical consumers. For example, in an embodiment, the subsea electrical power transmission system is a subsea electrical power grid.

According to an embodiment, the subsea DC power transmission path comprises a transmission cable connected to the rectifier and the rectifier is configured for feeding the transmission DC power into the transmission cable.

According to a further embodiment, subsea DC power transmission path further comprises a step-down converter. In an embodiment, the step-down converter is electrically coupled to the rectifier. According to a further embodiment, the step-down converter is configured for receiving the transmission DC power and providing, in response hereto, a converted DC power, wherein the voltage of the converted DC power is lower than the voltage of the transmission DC power. According to a further embodiment, the voltage of the transmission DC power is in a range between 50 kilovolts and 200 kilovolts, e.g. between 80 kilovolts and 140 kilovolts. According to an embodiment, the rectifier is configured for providing the transmission DC power with a voltage in the specified range. For example, in an embodiment, the rectifier is configured for converting the voltage level from the voltage of the electrical input power to the voltage of the transmission DC power. For example, in one embodiment, the rectifier acts as a step-up converter. According to another embodiment, the rectifier acts as a step-down converter. In other embodiments, the rectifier includes a rectifier portion and a converter portion, wherein the rectifier portion is configured for converting an AC power into a primary DC power and the converter portion is configured for converting the primary DC power into the transmission DC power.

High DC voltage of the transmission DC power, e.g. the transmission DC power with a voltage as specified above may allow for transmission of electrical power over 200 kilometers (km) and beyond. Accordingly, in an embodiment, the subsea electrical power transmission system is configured for transmission of the transmission DC power over distances that exceed 200 kilometers.

According to a further embodiment, the voltage of the converted DC power is in a range between 5 kilovolts and 20 kilovolts, e.g. between 8 kilovolts and 14 kilovolts.

According to a further embodiment, the subsea electrical power transmission system further comprises an further converter coupled to the step-down converter, the further converter inverter being configured for receiving the converted DC power and providing in response hereto an converter output power with a time varying voltage. According to an embodiment, the time varying voltage is a pulsating voltage. According to an embodiment, the further converter is an inverter and the time varying voltage provided by the further converter is an AC voltage. According to an embodiment, the further converter is coupled to a consumer, e.g. a motor. Hence in an embodiment, the time varying voltage is fed to a motor.

The step-down converter allows for an increased voltage of the transmission DC power while still maintaining the power below a threshold value at a consumer or at a consumer-related element. For example, according to an embodiment, the step-down converter allows for a voltage of the transmission DC power which is above a maximum voltage of the consumer or of the consumer-related element, e.g. above a maximum voltage of the further converter, while still maintaining the voltage of converted DC power below the threshold value, e.g. below the maximum voltage of the further converter. Herein, the “maximum voltage of a consumer or consumer-related element” is the maximum voltage at which the consumer or the consumer-related element is operable. For example, the “maximum voltage of the further converter” is the maximum voltage at which the further converter is operable. The increased voltage of the transmission DC power in turn allows for even more reduced cable losses and hence decreased costs.

According to a further embodiment, one or more of the elements of the subsea electrical power transmission system (referred to as system element in the following) is configured for installation at a seabed. An element of the subsea electrical power transmission system (system element) is for example the step-down converter or the further converter. Accordingly, in an embodiment the step-down converter and/or the further converter are configured for installation at a seabed. For example, in respective embodiments the system element is capable of operating in a water depth below a predefined upper level, e.g. 100 meters (m), 800 meters, 2000 meters or 3000 meters with each upper level corresponding to a respective embodiment of the herein disclosed subject matter. According to respective further embodiments, the system element is capable of operating under a pressure corresponding to the specified depth, wherein in one embodiment the pressure is a pressure generated by sea water of the specified depth and in another embodiment the pressure is a pressure generated by fresh water of the specified depth. According to respective further embodiments, the system element is capable of operating up to predefined lower level of water depth, e.g. 200 meters (m), 1000 meters, 3000 meters or 4000 meters with each lower level corresponding to a respective embodiment of the herein disclosed subject matter, leading to respective pressures which are dependent on the density of the water, e.g. on the temperature and on the type of water (sea water or fresh water).

According to a further embodiment, one pole of a DC power in the subsea DC power transmission path is grounded. For example, in an embodiment one pole of the transmission DC power and/or one pole of the converted DC power is grounded, i.e. the respective pole is electrically connected (i.e. galvanically connected) to ground. This may keep the isolation stress on the individual components of the subsea electrical power transmission system at an acceptable level in case of a ground fault. According to an embodiment, the minus pole of the transmission DC power is grounded. According to a further embodiment, the current path of the grounded pole provides, in an embodiment, a galvanic connection of the respective output pole of the rectifier and the respective input pole of the inverter, or, in another embodiment, provides a galvanic connection of the respective output pole of the rectifier and the respective input pole of consumer.

According to an embodiment, the subsea electrical power transmission system comprises a switching element, e.g. a semiconductor switch, for electrically coupling a system element of the subsea DC transmission system to the rectifier or decoupling the system element from the rectifier. For example, in an embodiment, the subsea DC power transmission path comprises the switching element. A semiconductor switch has turned out to be particularly suitable to operate under the subsea conditions in accordance with embodiments of the herein disclosed subject matter. According to a further embodiment, the system element is e.g. the consumer, the further converter, etc.

In the above mentioned embodiments and generally herein, “electrically coupling/decoupling” does not necessarily imply an direct connection of the coupled entities, nor does it necessarily imply an electrical (galvanical) connection. Rather, the electrically coupled entities may be galvanically separated in one embodiment. In such an embodiment the electrical coupling nonetheless provides for transfer of electrical energy between the electrically coupled entities. According to a further embodiment, electrical decoupling prohibits the transfer of electrical energy between the electrically decoupled entities. Further, any intermediate element may be located between the electrically coupled entities. For example, according to an embodiment, a power distribution bus is electrically coupled to the step-down converter for receiving the converted DC power. In such a case, the switching element may be electrically coupled (or electrically connnected) to the power distribution bus. According to an embodiment, the switching element is coupled between the rectifier and the electrical consumer. For example, in an embodiment the switching element is coupled (for example electrically connected) between the power distribution bus and the electrical consumer. According to another embodiment, the switching element is coupled (for example electrically connected) between the power distribution bus and the inverter.

According to an embodiment, one or more system elements, e.g. all system elements or all subsea system elements, e.g. any power electronic module such as the converter, the further converter or the switching element of the subsea electrical power transmission system is installed in an dielectric-fluid-filled container. For example, according to a further embodiment, the step-down converter and/or the semiconductor switch is installed in an dielectric-fluid-filled container. An example of a dielectric fluid is oil. However other dielectric fluids (liquids or gases) may be used depending on the application.

According to a second aspect of the herein disclosed subject matter, a method of operating a subsea electrical power transmission system is provided, the method comprising receiving electrical input power with a time varying voltage from a source of electrical energy; and converting the electrical input power into a transmission DC power and feeding the transmission DC power into a subsea DC power transmission path.

According to an embodiment of the second aspect, the method further comprises converting the transmission DC power into a converted DC power, wherein the voltage of the converted DC power is lower than the voltage of the transmission DC power.

According to a further embodiment, the method further comprises grounding one pole of a DC power in the subsea DC power transmission path between the source of electrical energy on the one hand and a consumer or terminals to which the electrical consumer is connectable on the other hand. For example, in an embodiment, the method comprises grounding one pole of a DC power in the power transmission path which in an embodiment extends between the source of electrical energy and an electrical consumer. According to a further embodiment, the method comprises grounding one pole of a DC power in the power transmission path between the source of electrical energy and terminals to which an electrical consumer is connectable. For example, according to respective embodiments, the method further comprises grounding of one pole of the transmission DC power and/or of the converted DC power.

According to still further embodiments of the second aspect, the functions as disclosed with regard to the first aspect are performed. These functions may be performed in any suitable way. Accordingly, the device features specified with regard to the first aspect are not limiting for the definition of embodiments of the method of the second aspect. Only the disclosed functions limit respective embodiments of the second aspect. However, according to an embodiment, these functions are performed with the configuration of the subsea electrical power transmission system as discloses with regard to the first aspect.

In the above there have been described and in the following there will be described exemplary embodiments of the subject matter disclosed herein with reference to a subsea electrical power transmission system and a method for operating subsea electrical power transmission system. It has to be pointed out that of course any combination of features relating to different aspects of the herein disclosed subject matter is also possible. In particular, some embodiments have been described with reference to apparatus type claims whereas other embodiments have been described with reference to method type claims. However, a person skilled in the art will gather from the above and the following description that, unless other notified, in addition to any combination of features belonging to one aspect also any combination between features relating to different aspects or embodiments, for example even between features of the apparatus type claims and features of the method type claims is considered to be disclosed with this application.

The aspects and embodiments defined above and further aspects and embodiments of the present invention are apparent from the examples to be described hereinafter and are explained with reference to the drawings, but to which the invention is not limited.

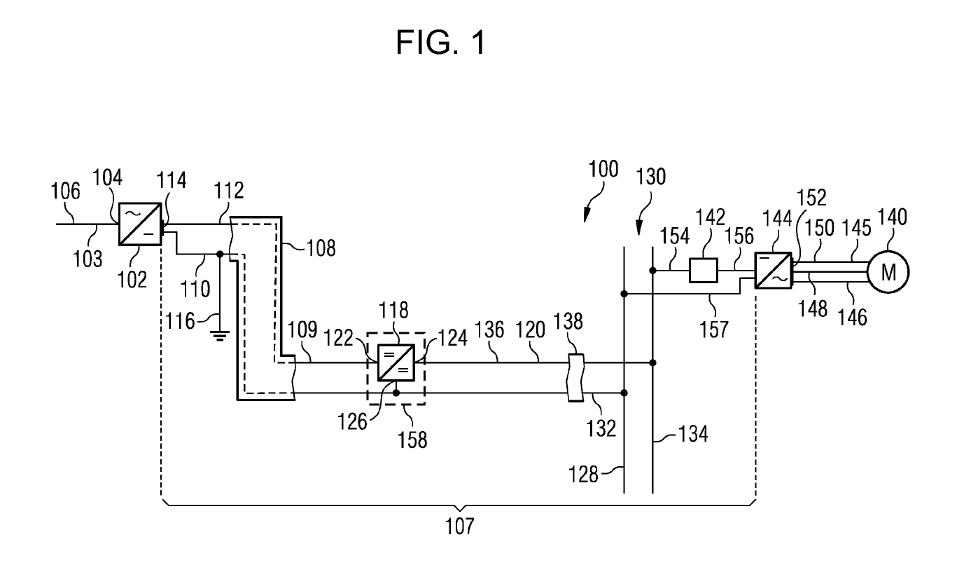

FIG. 1 shows a subsea electrical power transmission system 100 comprising a rectifier 102 being configured for receiving electrical input power 103 with a time-varying voltage at an input 104 of the rectifier 102. The electrical input power 103 is received from a source of electrical energy, e.g. a land-based electricity network (a land-based power grid), indicated at 106 in FIG. 1. The subsea electrical power transmission system 100 further comprises a subsea DC power transmission path 107. In accordance with an embodiment, the subsea DC power transmission path 107 comprises a transmission cable 108 electrically connected to the rectifier 102. In accordance with further embodiments of the herein disclosed subject-matter, the rectifier 102 is configured for converting the electrical input power 103 received at the input 104 into a transmission DC power 109 and feeding the transmission DC power 109 into the transmission cable 108. According to an embodiment, the voltage of the transmission DC power 109 is typically 100 kilovolts (kV).

According to an embodiment, the transmission cable 108 comprises at least two conductors 110, 112 which are connected to the output 114 of the rectifier 102. The output 114 provides at least two poles, a minus pole connected to the first conductor 110 and a plus pole connected to the second conductor 112 of the transmission cable 108. In accordance with an embodiment, the minus pole of the rectifier 102 is connected to ground, indicated at 116 in FIG. 1.

In accordance with a further embodiment, the subsea electrical power transmission system 100 comprises a step-down converter 118 being connected to the transmission cable 108. The step-down converter 118 is configured for receiving the transmission DC power 109 from the rectifier 102 and providing, in response to the received transmission DC power, a converted DC power 120. The voltage of the converted DC power 120 is lower than the voltage of the transmission DC power 109.

According to an embodiment shown in FIG. 1, the step-down converter 118 is a step-down chopper having a first power input 122 that is electrically connected to the plus pole of the output 114 of the rectifier 102. The step-down chopper 118 further comprises a power output 124 and a ground terminal 126 that is connected to the grounded first conductor 110 of the transmission cable 108. The ground terminal of the step-down converter 118 is further connected to a first conductor 128 of a power distribution bus 130 via a conductor 132. The power output 124 of the step-down converter 118 is electrically connected to a second conductor 134 of the power distribution bus 130 via a conductor 136. The conductors 132, 136 which connect the step-down converter 118 to the power distribution bus 130 are a part of a further transmission cable 138 in one embodiment. The conductors 110 and 132 may be portions of a single piece or may be provided in the form of individual pieces.

To the power distribution bus 130 one or more electrical consumers are coupled, one of which is exemplarily shown and indicated at 140 in FIG. 1.

In accordance with an embodiment of the herein disclosed subject-matter, the electrical consumer 140 is coupled to the power distribution bus 130 via a semiconductor switch 142 and, optionally, a further converter e.g. an inverter 144 as shown in FIG. 1. According to an embodiment, the inverter 144 is a variable speed drive (VSD) inverter, configured to control the speed of a speed controllable consumer, e.g. of the motor 140, coupled thereto. In an embodiment, for a motor requiring 6.6 kilovolts (kV), the voltage of the inverter input power, e.g. the converted DC power 120, will be typically 10 kilovolts (kV).

In response to the inverter input power 120 the inverter provides an inverter output power 145 with a time varying voltage. According to an embodiment, the inverter 144 provides two or more, for example three, phases of inverter output power 145 which are indicated at 146, 148, 150 in FIG. 1. Further in accordance with an embodiment of the herein disclosed subject-matter, the inverter 144 provides a time-varying voltage at each phase 146, 148, 150 at its output 152.

In accordance with an embodiment, the semiconductor switch 142 is electrically connected between the power distribution bus 130 and the inverter 144 by means of electrical conductors 154, 156. According to an embodiment, only one phase of the converted DC power, e.g. the plus pole as shown in FIG. 1, is switchable by the semiconductor switch 142. According to other embodiments, the semiconductor switch 142 is configured at arranged for switching two poles or, in case of a multipole DC power, more than two poles of the converted DC power (not shown in FIG. 1). However, if the converted DC power consists of two poles, a plus pole and a minus pole, wherein the minus pole is connected to ground, switching the plus pole only is sufficient for properly disconnecting the inverter 144 from the power distribution bus 130. In such an embodiment, as shown in FIG. 1, the first conductor 128 (minus pole) of the power distribution bus 130 is directly electrically connected to the inverter 144 in one embodiment, e.g. by a conductor 157.

One or more of the power electronic modules may be installed in an dielectric-fluid filled container 158. According to an embodiment, the dielectric-fluid filled container 158 is configured so as to expose the power electronic module to the ambient pressure at the seabed.

It should be noted that the above described embodiments may be varied while still remaining in accordance with the appended claims. For example, in an embodiment, the step-down converter may be omitted. According to another embodiment, the DC power is not a dipole DC power but rather a multipole DC power having more than two poles.

Further, the specified number and arrangement of rectifiers, converters and inverters does not exclude other numbers and arrangements of such entities. Further it should further be noted that a subsea electrical power transmission system as disclosed is not limited as to include the dedicated entities described in some embodiments above. Further, the herein disclosed subject matter may be implemented in various ways in various locations in the subsea electrical power transmission system while still providing the desired functionality.

It should be noted that the term “comprising” does not exclude other elements or steps and the “a” or “an” does not exclude a plurality. Also elements described in association with different embodiments may be combined. It should also be noted that reference signs in the claims should not be construed as limiting the scope of the claims.

In order to recapitulate the above described embodiments one can state:

For transmission of power to subsea installations at long distances, the use of DC is attractive as it may reduce the cable losses. In order to transfer the power over a long distance, the voltage can be increased to reduce losses and save cost of the cable. In order to comply with electrical consumer requirements, the voltage may be converted at the destination site.

Embodiments of the herein disclosed subject matter include a rectifier located at the source of the energy feeding a subsea DC power transmission path, e.g. a transmission cable with DC power. The voltage level can be adjusted to the actual installation and may typically be 100 kV. To reduce the voltage at the destination, e.g. a power distribution bus, a step down chopper is used in one embodiment. This reduces the voltage to a suitable input voltage for a VSD-inverters (VSD: variable speed drive) feeding electrical consumers such as motors.

For a motor requiring 6.6 kV the inverter input will typically be 10 kV. In order to reduce the consequences of a possible ground fault the common pole of the DC power, typically the minus, can be grounded. This will keep the isolation stress on the individual components at an acceptable level in case of a ground fault. For the purpose of connecting and disconnecting the VSD-inverters to the power distribution bus, a semiconductor switch may be installed. This may have current limiting function for limiting the fault currents and disconnecting a faulty inverter/motor set.

All power electronic modules may be installed in dielectric-fluid filled canisters and exposed to the ambient pressure at the seabed.

What is claimed is:

1. Subsea electrical power transmission system comprising:
a rectifier configured to receive electrical input power with a time varying voltage from a source of electrical energy; and
a subsea DC power transmission path connected to the rectifier;
the rectifier configured to convert the electrical input power into a transmission DC power and feeding the transmission DC power into the subsea DC power transmission path.

2. Subsea electrical power transmission system according to claim 1, further comprising:
a step-down converter in the subsea DC power transmission path;
the step-down converter configured to receive the transmission DC power and provide, in response hereto, a converted DC power, wherein the voltage of the converted DC power is lower than the voltage of the transmission DC power.

3. Subsea electrical power transmission system according to claim 2, wherein the voltage of the converted DC power is in a range between 5 kilovolts and 20 kilovolts.

4. Subsea electrical power transmission system according to claim 2, further comprising a further converter coupled to the step-down converter, the further converter configured to receive the converted DC power and providing in response hereto a converter output power with a time varying voltage.

5. Subsea electrical power transmission system according to claim 2, wherein the step-down converter is installed in a dielectric-fluid-filled container.

6. Subsea electrical power transmission system according to claim 2, wherein the step-down converter is configured for installation at a seabed.

7. Subsea electrical power transmission system according to claim 1, wherein one pole of the transmission DC power is grounded.

8. Subsea electrical power transmission system according to claim 1, the subsea DC power transmission path further comprising a power distribution bus.

9. Subsea electrical power transmission system according to claim 8, further comprising a switching element for electrically coupling/decoupling a consumer to the power distribution bus.

10. Method of operating a subsea electrical power transmission system, the method comprising:
receiving electrical input power with a time varying voltage from a source of electrical energy; and
converting the electrical input power into a transmission DC power and feeding the transmission DC power into a subsea DC power transmission path.

11. Method according to claim 10, further comprising converting the transmission DC power into a converted DC power, wherein the voltage of the converted DC power is lower than the voltage of the transmission DC power.

12. Method according to claim 10, further comprising grounding one pole of a DC power in the subsea DC power transmission path between the source of electrical energy on the one hand and a consumer or terminals to which the electrical consumer is connectable on the other hand.

13. Method according to claim 11, wherein the voltage of the converted DC power is in a range between 5 kilovolts and 20 kilovolts.

14. Method according to claim 11, further comprising a further converter coupled to the step-down converter receiving the converted DC power and providing in response hereto a converter output power with a time varying voltage.

15. Method according to claim 11, wherein the conversion of the transmission DC power into a converted DC power is performed by a step-down converter installed in a dielectric-fluid-filled container.

16. Method according to claim 11, wherein the conversion of the transmission DC power into a converted DC power is performed by a step-down converter installed at a seabed.
